(19) United States
(12) Patent Application Publication
(10) Pub. No.: US 2004/0080772 A1
(43) Pub. Date: Apr. 29, 2004

(54) Securing, tracking, and remotely printing sensitive data

(76) Inventor: Lawrence M. Snyders, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/279,642

(22) Filed: Oct. 24, 2002

(51) Int. Cl. G06F 3/12; G06F 15/00; G06F 11/30; H04L 9/32

(52) U.S. Cl. 358/1.14; 358/1.15; 713/201

(57) ABSTRACT

Systems and methods are disclosed for securing and tracking a document transmitted along a workflow path from a customer to a remote printing facility. The customer contains a document source, a print-job initiator, and a security processor. The document source provides the document to be transmitted to the printing facility for printing. The print-job initiator identifies sensitive fields within the document and establishes a new print job. The printing facility is connected to the customer along the workflow path and contains printing equipment and a security processor. A tracking device, in communication with the security processors of the customer and printing facility, tracks the transmission of the document along the workflow path.

### TECHNICAL FIELD OF THE INVENTION

The present invention is generally related to commercial printing and publishing. More particularly, the present invention is related to systems and methods for securing sensitive fields of documents, transmitting the documents over an open network to a printing facility, and tracking the transmission of the documents over the network.

### BACKGROUND OF THE INVENTION

In the field of printing and publishing, many companies own private printing equipment where electronic documents may be printed onto a recordable medium, such as paper. Although magazine and newspaper printing facilities are easily recognized as major players in the field of printing, additional companies may have internal printers and offset-type presses for printing various types of documents. For example, some banks have printing equipment for printing documents such as bank checks, personal checks, bonds, etc. Another example of an internal printing facility includes a utility company that prints utility bills for its customers. Internal printing may also be done by a printing division of a large company to print payroll checks for its employees.

Although some printing jobs are not of a sensitive nature, occasionally it may be desirable to closely monitor a printing job when secret, confidential, or sensitive data is printed. When companies perform internal printing with private equipment, tracking of the electronic documents through the printing network may be performed in order to insure that secret, confidential, or sensitive data is not improperly used. Tracking the printing job on private equipment can be easily carried out by monitoring a company's internal network along which documents are sent from a storage medium to a printer.

Since some companies do not own printing equipment or they may have a need for additional printing capacity, they may contract a printing facility to take care of at least some of their printing needs. In a contracting situation, in which a customer has electronic documents to be printed, a copy of the document is sent to the contracted printing facility for printing. The copy may be placed on a compact disk read only memory (CD-ROM), floppy diskette, or other portable storage medium. The storage medium is then physically hand-carried or delivered to the printer. This solution may require that several people handle the storage medium in order to get the document or documents to the printer. Also, as the distance between the document owner and printer increases, the more likely that the document may end up in the wrong hands.

Another way that a copy of the electronic documents may be delivered is by sending the document via a network connection. If this network connection is a local area network (LAN) connection or the like, then the tracking can be monitored fairly easily. However, it may be desirable to allow a customer to contract printing jobs to printing facilities remotely located from the customer. In this case, the network connection might be made using an open network such as the Internet, such that electronic documents can be delivered to the printing facility using electronic mail. A problem with this solution is that unauthorized persons may own software capable of sniffing out the open network and intercepting the documents. In this case, using an open network, a document having confidential or sensitive data would not have the needed security to be safely transmitted without the possibility of a security breach.

In U.S. Pat. No. 6,378,070, issued on Apr. 23, 2002 to Chan et al., a solution is provided wherein a secure printer and a method for securing a printer are disclosed. Chan et al. incorporates a smart card reader in a secure printer. The smart card reader reads a recipient's smart card such that documents can be transmitted to the intended recipient. An encrypted session key is forwarded to the smart card for decryption. The decrypted session key is used to decrypt an encrypted document to be printed.

Although Chan et al. disclose an effective method for securing a printer, additional security measures may be needed to properly protect and secure sensitive documents. Thus, a need exists in the industry to address the aforementioned deficiencies and inadequacies.

### SUMMARY OF THE INVENTION

Systems and methods for securing and tracking a document transmitted over an open network are disclosed herein. One securing and tracking system includes a customer having a document for providing a document and a print-job initiator for identifying sensitive fields within the document and for establishing a print job. The system further includes a printing facility connected to the customer along a workflow path. The printing facility has printing equipment for printing the document. The system further includes a tracking device that communicates with security processors located with the customer and printing facility.

A securing and tracking method includes securing the sensitive fields within a document to be transmitted through secure junctures over an open network. The document is transmitted along a workflow path through the secure junctures. The method further includes tracking the location of the document through the secure junctures and printing the document.

### BRIEF DESCRIPTION OF THE DRAWINGS

Many aspects of the invention can be better understood with reference to the following drawings. Like reference numerals designate corresponding parts throughout the several views.

FIG. 1 is a block diagram of an embodiment illustrating a general view of a tracking system in accordance with the present invention.

FIG. 2 is a block diagram of an embodiment illustrating a more detailed view of the tracking system of FIG. 1.

FIG. 3 is a block diagram of an exemplary embodiment of the originator shown in FIG. 2.

FIG. 4 is a block diagram of an exemplary embodiment of the document augmentation facility shown in FIG. 2.

FIG. 5 is a block diagram of an exemplary embodiment of the raster image processor (RIP) shown in FIG. 2.

FIG. 6 is a block diagram of an exemplary embodiment of the printer shown in FIG. 2.

FIG. 7 is a block diagram of an exemplary embodiment of the finisher shown in FIG. 2.

FIG. 8 is a block diagram of an exemplary embodiment of the tracking device shown in FIG. 2.

FIG. 9 is a flow chart showing an embodiment of a general method for tracking the transmission of sensitive documents to a printer in accordance with the present invention.

FIG. 10 is a flow chart illustrating an embodiment of a method for setting up a workflow path and creating a data package.

FIG. 11 is a flow chart of an exemplary embodiment of a method for creating a job ticket.

FIG. 12 is a flow chart of an embodiment of a method for tracking the transmission of the data package through the junctures.

FIG. 13 is a flow chart of an embodiment of a method for performing the functions of the junctures.

### DETAILED DESCRIPTION OF THE INVENTION

Disclosed herein are securing and tracking systems and methods for transmitting an electronic document over an open network, such as the Internet. More specifically, the transmitted document contains data to be printed by a printing facility that is connected to the open network. The data in the document may include at least some sensitive information that the document owner wishes to protect from unauthorized network locations and accesses. This sensitive information is identified and secured before transmission and the document is tracked by a tracking device during transmission.

The securing and tracking systems are intended for customers that have a need for remote printing of sensitive data. For example, banks, payroll departments, utility companies, state lottery bureaus, etc., may utilize the securing and tracking systems.

When the customer identifies the sensitive data within the documents using the securing and tracking systems, the customer can transmit the documents to a reliable printing facility with the confidence that the document and, especially, the sensitive fields of the document are secure and that the document is safely transmitted to the printing facility. The customer can also have confidence that the whereabouts of the document are known by the securing and tracking systems at all times.

Before the document is transmitted over the network, the customer identifies sensitive fields embedded within the document. When the sensitive fields within the documents have been identified, a tag is added to the document indicating the location of the sensitive fields within the document. The term “tag” used herein refers to a block of data attached to the original document. The tag contains information identifying the location of the sensitive fields. With the proper software and/or circuitry installed at set-up, the printing facility and other processing junctures can separate the tag from the document to access the information within the tag. The identified sensitive locations are secured or encrypted using known security and encryption technology.

The sensitive fields referred to herein include data, information, or images that the document owner wishes to protect and secure as the document traverses the network. For example, the sensitive fields may include one or more fields from the list including names, addresses, social security numbers, cash values of negotiable instruments, serial numbers, issue dates of bonds, bank names, checking account numbers, routing numbers, check numbers, etc. These sensitive fields may be included within such documents as payroll checks, bonds, checks, or other types of negotiable instruments, as well as invoices and bills. Further examples of sensitive fields include digital photographs or digitally stored images or artwork. Other examples include image fonts such as signature fonts having a bit stream image of a legal signature that may appear on checks, bonds, etc. The sensitive fields may further include the winning numbers or symbols printed on game pieces and lottery tickets having a scratch-and-reveal format.

When a customer and a printing facility agree upon a contracted print job, the customer inputs details of the print job, e.g. the type of jobs to be performed and the selected printing facility. These job details constitute what is referred to hereinafter as a job ticket. It may be desirable that a number of printing facilities be available for the customer to choose from in order that the customer may shop around for the best deal. Additionally, printing facilities may benefit by attracting customers from remote locations.

In addition to attaching the tag to the original document, the job ticket is also added to the document. The job ticket includes a description of jobs or information about the types of jobs to be performed on the document, as discussed above.

Besides printing and post-printing jobs, other jobs may be performed on the document. For example, the document may be further processed by another party to enhance the document. The customer enters the entire job description into the job ticket, describing the tasks that the printer and other interposed junctures are to perform on the document. The original document, having sensitive and/or non-sensitive fields, is combined with the tag and the job ticket to constitute what is referred to hereinafter as a “data package.” Security measures are applied to the data package before the data package is sent onto the network.

Once the securing and tracking system has secured the data package, it then tracks the data package as it is transmitted over the network. The data package is transmitted along a path that is referred to herein as a workflow path. Various parties that access the document in any way, e.g. to process and/or print the document, are connected within the workflow path. These parties are referred to herein as “junctures.” The securing and tracking systems include security processors that are installed in each of the reliable junctures. The securing and tracking systems further include a tracking device that communicates with the security processors to insure that the document is properly handled by each juncture along the workflow path. The security processors located at each of the reliable junctures are pre-installed with a unique encryption key that enables the junctures to participate in the transmitting, processing, and printing of the document in the workflow path.

As the data package is transmitted to the printing facility via secure junctures, the secure junctures perform a designated function on the document, according to the needs and desires of the customer, as described in the job ticket. During the transmission along the workflow path, the tracking device tracks the transmission and verifies that the data package is following the prescribed workflow path that was intended, according to the job ticket. If the tracking device detects that an error has occurred or that a juncture is improperly handling the document, then the print job is aborted and the customer is notified of the error or security breach. Otherwise, when all goes well, the document is transmitted to the printer for printing. Furthermore, the tracking device is notified of the success or failure of the printing or post-printing processes and informs the customer of the printing and post-printing status.

The securing and tracking system of the present disclosure can be implemented in hardware, software, firmware, or a combination thereof. In the disclosed embodiments, the securing and tracking system is implemented in software or firmware that is stored in a memory and that is executed by a suitable instruction execution system. If implemented in hardware, as in an alternative embodiment, the securing and tracking system can be implemented with any or a combination of the following technologies, which are all well known in the art: a discrete logic circuit having logic gates for implementing logic functions upon data signals, an application specific integrated circuit (ASIC) having appropriate combinational logic gates, a programmable gate array (PGA), a field programmable gate array (FPGA), etc.

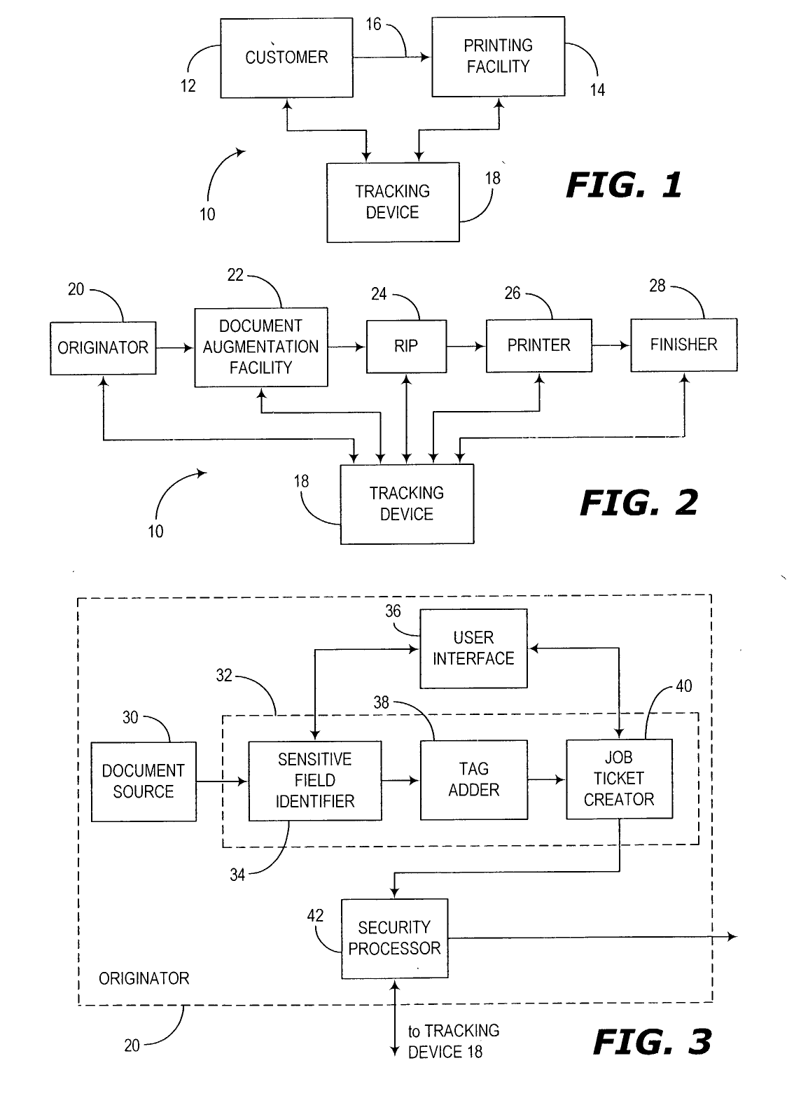

FIG. 1 illustrates an embodiment of a securing and tracking system 10. A customer 12 is connected to a remote printing facility 14 via a network connection 16. The customer 12 and printing facility 14 contain security processors (discussed below) that are installed therein allowing the customer 12 and printing facility 14 to transmit and receive secured data over the network connection 16. Without security processors, the customer 12 and printing facility 14 are unauthorized and may not participate in any print jobs involving the securing and tracking system 10. A tracking device 18 communicates with the security processors within the customer 12 and printing facility 14. The tracking device 18 insures that the transmitted data is properly secured and tracks the secured data during transmission from the customer 12 to the printing facility 14.

The customer 12 may utilize a data processor (not shown) or computer system to create or store electronic documents. The customer 12 identifies sensitive fields within the document or documents to be printed. A tag is created (FIGS. 3 and 4) that stores information about the location of the identified sensitive fields. Using this tag, security mechanisms secure the identified sensitive fields. Additionally, a job ticket is appended (FIGS. 3 and 4) to the original document detailing the jobs to be performed.

The original document is combined with the tag and job ticket to create a data package. The customer 12 contains conventional circuitry and/or software with the ability to transmit the data package over the network connection 16. The network may be an open network such as the Internet or may alternatively be a local area network (LAN). The printing facility 14 receives the data package and converts the original document into a format that is understandable to printing equipment such as an offset press or the like.

The tracking device 18 controls and tracks the workflow of the document from the customer 12 to the printing facility 14 over the network connection 16. The tracking device 18 insures that the document is properly secured before being transmitted over the network connection 16 and monitors the printing facility 14 and any intermediate junctures (FIG. 2) to insure that the document is accessed only by authorized junctures along the workflow.

All of the authorized junctures, as well as the printing facility, contain security processors (discussed below) that communicate with the tracking device 18 to notify the tracking device 18 of the arrival and departure of the document. The security processors are further configured to purge the memory locations, buffers, and any equipment within the junctures after the document has been processed by the juncture and transmitted to the next juncture. Since each juncture may temporarily store the document or parts of the document during processing, the security processor insures that all remnants of the document are erased or eliminated.

FIG. 2 is a block diagram of an embodiment showing additional junctures within the workflow path of the securing and tracking system 10. The junctures, according to the embodiment of FIG. 2, include an originator 20, a document augmentation facility 22, a raster image processor (RIP) 24, a printer 26, and a finisher 28. Other embodiments may include more or fewer junctures along the workflow path, depending on the needs or requests of the customer. The originator 20 and the document augmentation facility 22 are examples of two entities that may create or contribute to the creation of the document to be printed. Alternatively, the originator 20 and the document augmentation facility 22 may be part of the same facility such that the document is completely created before being transmitted along the network connection 16. The customer 12 may be one or both of these entities. The printing facility 14, shown in FIG. 1, may comprise one or more of the RIP 24, printer 26, and finisher 28.

In one example, a customer, such as a bank, is the originator 20 that creates a document such as a check or bond having a number of sensitive fields, such as names, addresses, social security numbers, account numbers, etc. The originator 20 or bank may contract the document augmentation facility 22 to provide the background layout or design to be printed on the check or bond. In an alternative example, a customer, such as a bank, is the document augmentation facility 22. In this case, the originator 20 may be contracted to create the background layout first, and the document augmentation facility 22, e.g., the bank, adds the sensitive fields later.

One application of the securing and tracking system 10 may include the printing of game pieces and lottery tickets. The game pieces and lottery tickets mentioned herein refer to the type of tickets where the odds of winning have been predetermined and the number of winning and non-winning tickets is known. Examples of such game pieces and lottery tickets include scratch-and-reveal type tickets that have numbers or symbols printed underneath a scratch-off layer. In this application, the originator 20 may be a contracted artwork company that provides the background artwork shown on the game pieces and lottery tickets. This part of the game piece or lottery ticket is considered non-sensitive. The non-sensitive artwork is transmitted to the document augmentation facility 22, which, in this example, may be a state lottery bureau. The state lottery bureau augments the non-sensitive artwork with sensitive fields related to the lottery numbers. Since the lottery bureau is under a strict obligation to regulate the winning odds, the number of tickets printed, the number of winning tickets, prize amounts, and the number of losing tickets, these sensitive fields must be monitored and tracked so that the location of winning and losing tickets are known at all times. Therefore, in this example, the document augmentation facility 22 adds these sensitive fields to the document.

After the document augmentation facility 22 has augmented the document according to the specific requests described in the job ticket, the document augmentation facility 22 then transmits the document to the RIP 24. The RIP 24 may be part of the printing facility 14 or may alternatively be located in a separate facility. The RIP 24 manipulates the document to create an image file that is recognizable to a printing press or other type of printing equipment. The processed images from the RIP 24 are securely transmitted to the printer 26, which prints the images onto a recordable medium. The physical printed material from the printer 26 is transferred to the finisher 28, which performs any number of functions such as trimming, folding, binding, envelope stuffing, or other post-printing functions.

The tracking device 18 provides control to the junctures along the workflow path from the originator 20 to the finisher 28. The security processor within each juncture communicates with the tracking device 18 so that the location of the data package is known at all times. The tracking device 18 stores the tag and job ticket and monitors several conditions to ensure that the print job follows prescribed instructions. The details of embodiments of the respective junctures are now described with respect to FIGS. 3-7.

FIG. 3 illustrates an exemplary embodiment of the originator 20 shown in FIG. 2. The originator 20 comprises a document source 30 that creates, stores, and/or provides one or more documents. The document source 30 may include a memory device including random access memory (RAM), read only memory (ROM), or other suitable memory component. The document source 30 may include processing means (not shown) for internally creating a document and for altering, manipulating, combining, or creating data from one or more documents. A document to be securely printed by the securing and tracking system 10 is selected from the document source 30 and provided to a print-job initiator 32.

The print-job initiator 32 may be configured to have a sensitive field identifier 34, a tag adder 38, and a job ticket creator 40. The sensitive field identifier 34 locates different portions or fields of data within the document and presents the fields to a user interface 36. The user interface 36 receives input from a user to indicate which ones of the presented fields are to be identified as sensitive. The sensitive fields are the fields that the user wishes to be given a higher level of security while being transmitted over the network connection 16.

When the sensitive fields are identified, the document is sent to the tag adder 38 that adds a tag indicating the location of the sensitive fields within the document. The tag is also configured to include information about the transmission history of the document from the originator 20 to the finisher 28. The transmission history includes the location of the document at all times. The transmission history also includes arrival and departure times at each of the intermediate junctures.

The print-job initiator 32 further contains a job ticket creator 40. The job ticket may be added before the tag is added by positioning the job ticket creator 40 before the sensitive field identifier 34 and tag adder 38, between the document source 30 and the sensitive field identifier 34. The job ticket creator 40 is connected to the user interface 36 for receiving input from the customer as to the jobs to be performed by the junctures in route to the printing facility 14, as well as jobs to be performed by the printing facility 14 itself.

The job ticket contains instructions about the jobs along the workflow path and includes what junctures are authorized to perform these jobs. The job ticket further includes information as to what junctures are authorized to access the document, particularly the sensitive fields of the document. The authorized junctures are allowed access to only the parts of the document that the job ticket indicates.

Utilizing the user interface 36, the customer inputs the job ticket specifications that must be followed along the workflow path. If the jobs are not performed properly, then the tracking device 18 aborts the print job and notifies the customer that an error or security breach has occurred.

The originator 20 further contains a security processor 42. The security processor 42 includes software, firmware, and/or hardware elements configured to create a data package that includes the original document or documents to be printed, the tag added by the tag adder 38, and the job ticket created by the job ticket creator 40. The data package is incorporated together as a unit such that it is transmitted in its entirety along a secure transmission channel. The data package is secured, using known securing techniques, such that the data package cannot be broken into individual parts and cannot be re-routed through unauthorized junctures. The security processor 42 may include means for securing the data package using the most advanced security and encryption techniques available. The security processor 42 may alternatively access other security elements to provide the highest level of security available.

Furthermore, the security processor 42 transmits the tag and job ticket to the tracking device 18 in order to create a new print job to be tracked. The tracking device 18 at this point checks to make sure that the job request has come from a reliable and secure originator 20. If not, the tracking device 18 aborts the job and sends a notification to the customer 12 that the job could not be completed. If the tracking device 18 determines that the tag and job ticket are legitimate, then the tracking device 18 sends an indication to the security processor 42 that the data package may be sent onto the network connection 16.

FIG. 4 illustrates an embodiment of the document augmentation facility 22 that receives the data package from the originator 20 via the network connection 16. As mentioned above, the data package arrives in its entirety using a secure transmission channel. The data package is input into a security processor 44 of the document augmentation facility 22. The security processor 44 contains software, firmware, and/or hardware and is configured to operate in conjunction with the security processor 42 of the originator.

It should be noted that the originator 20 and the document augmentation facility 22 may contain a substantially similar configuration. These elements may be reversed if necessary, or even duplicated if more than one augmentation process is needed. For instance, a customer 12 may require the need of additional document augmentation facilities to add value to the document along the workflow path before being printed. The adding of value may include enhancing or supplementing the document with additional information, adding graphic designs or art, or adding sensitive information.

In addition to the security processors 42 and 44 of the originator 20 and document augmentation facility 22, security processors are also located in the remaining secure junctures for securely transmitting the data package. Furthermore, all of the security processors are configured to transmit and receive the data package among them and communicate with the tracking device 18, notifying the tracking device 18 of arrival and departure times of the data package at the particular junctures. The tracking device 18 further verifies the scope of the authorization of each juncture to instruct the juncture how to handle the incoming data package as it passes along the workflow path.

The security processors are further configured to notify the tracking device 18 when the juncture has finished its prescribed jobs and whether the jobs have been completed successfully or unsuccessfully. If successful, the tracking device 18 updates the tag by adding the information pertaining to the particular juncture, such as arrival and departure times and that the jobs have been performed successfully. If unsuccessful, the tracking device 18 aborts the job and reports to the customer 12 the occurrence of the error and the statistics concerning the error.

When security processor 44 receives instruction from the tracking device 18 that the data package may be processed, the security processor 44 decrypts the tag and job ticket using an encryption key that is included within the security processor 44 when the securing and tracking system 10 is originally installed. The security processor 44 uses the instructions from the job ticket about what jobs the document augmentation facility 22 is meant to perform on the data package. Using information about the location of the sensitive fields, such information being retrieved from the decrypted tag, the security processor 44 sends the portions of the document within the data package to augmentation equipment 46. The augmentation equipment 46 may include any type of processors or the like to augment the document. For instance, the augmentation equipment 46 may add artwork, photographs, symbols, decals, and other various non-sensitive fields to the document. In addition, the augmentation equipment 46 may add sensitive fields such as names, signature fonts, cash values, account numbers, and other types of sensitive fields to the document.

The document augmentation facility 22 further includes a sensitive field identifier 48 that operates in substantially the same manner as the sensitive field identifier 34 of the originator 20. Therefore, it is possible that sensitive fields are added in the originator 20, the document augmentation facility 22, or both. Furthermore, the sensitive field identifiers 34 and 48 both identify any new sensitive fields added or created within the document at each of the respective junctures. The sensitive field identifier 48 operates together with a user interface 50 for receiving input from a user regarding the location of the sensitive fields. Alternatively, an automatic processor may replace the user interface 50 for automatically recognizing sensitive fields according to preset criteria.

The document augmentation facility 22 further includes a tag adder 52 that adds a tag, if necessary. If a tag has already been added by the tag adder 38 of the originator 20, then the tag adder 52 may be replaced with a tag updating means for adding information of the location of new sensitive fields added by the augmentation equipment 46.

If necessary, the documentation augmentation facility 24 may also include a job ticket creator 54 if a job ticket is not created by the originator 20 or other documentation augmentation facilities. The job ticket creator 54 operates with the user interface 50 to receive the customer's input regarding information about the printing job. The job printing information may include the types of jobs to be performed and what junctures are to perform them. The job ticket may also include information about what portions or fields of the document the particular junctures are authorized to access.

After the augmentation equipment 46 has performed its functions of augmenting the document, identifying additional sensitive fields, adding or updating the tag, and creating the job ticket, if necessary, the augmented document is returned to the security processor 44. The security processor 44 notifies the tracking device 18 about the success or failure of the augmentation procedures.

The security processor 44 contains a receiving means for receiving an updated tag from the tracking device 18. Once the security processor 44 receives the updated tag, the security processor 44 re-encrypts the tag, creates an augmented data package from the augmented document, updated tag, and job ticket, and transmits the augmented data package over the network connection 16. After the augmented data package has left the document augmentation facility 22, the security processor 44 is configured to perform the function of purging any memory components, temporary storage devices, buffers, or other components that electronically or physically store portions or fields of the data package. This purging procedure involves erasing or eliminating any remnant of the data package.

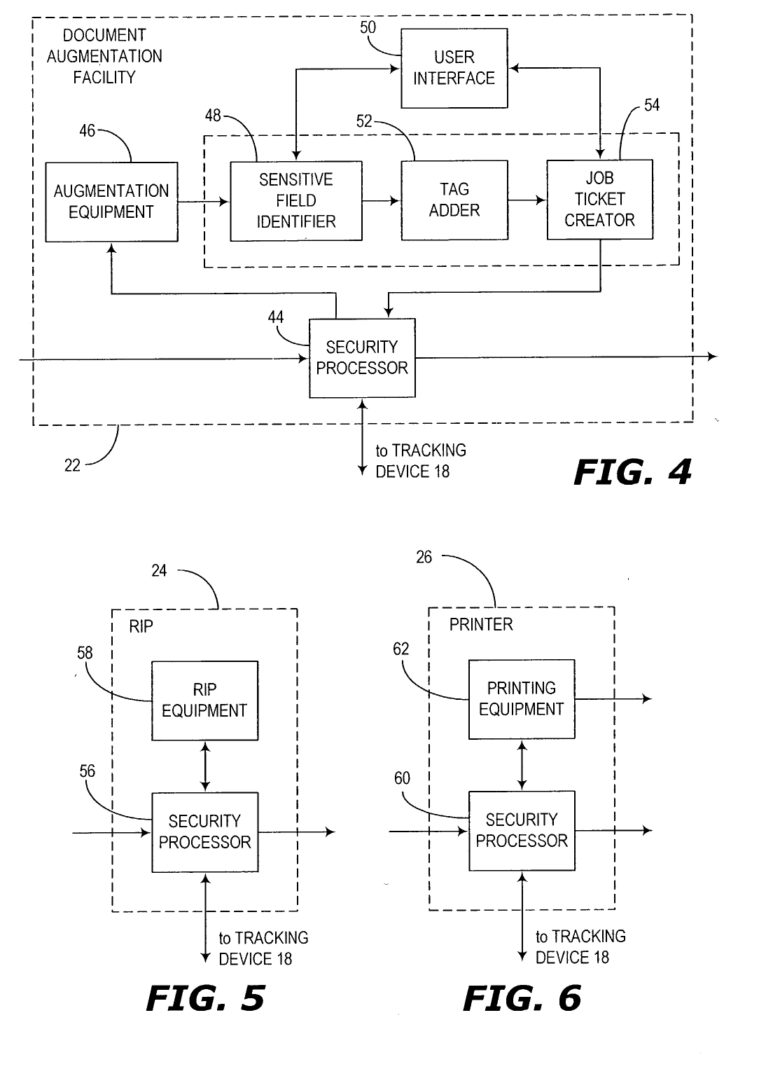

FIG. 5 is block diagram illustrating an embodiment of the RIP 24, as shown in FIG. 2. The augmented data package arrives at the RIP 24 and is received by another security processor 56. The security processor 56 notifies the tracking device 18 of the arrival of the data package and sends the tag and job ticket to the tracking device 18. Then, the security processor 56 waits for authorization from the tracking device 18 to continue. If so authorized, the security processor 56 decrypts the tag and job ticket to determine what jobs are to be performed. The data within the document or documents are sent from the security processor 56 to RIP equipment 58. The RIP equipment 58 processes the data and converts the data into image data having a format that can be recognized by printing equipment. The image data is re-combined with an updated tag from the tracking device 18 and the job ticket to create an updated data package. This data package is transmitted by the security processor 56 to the next juncture.

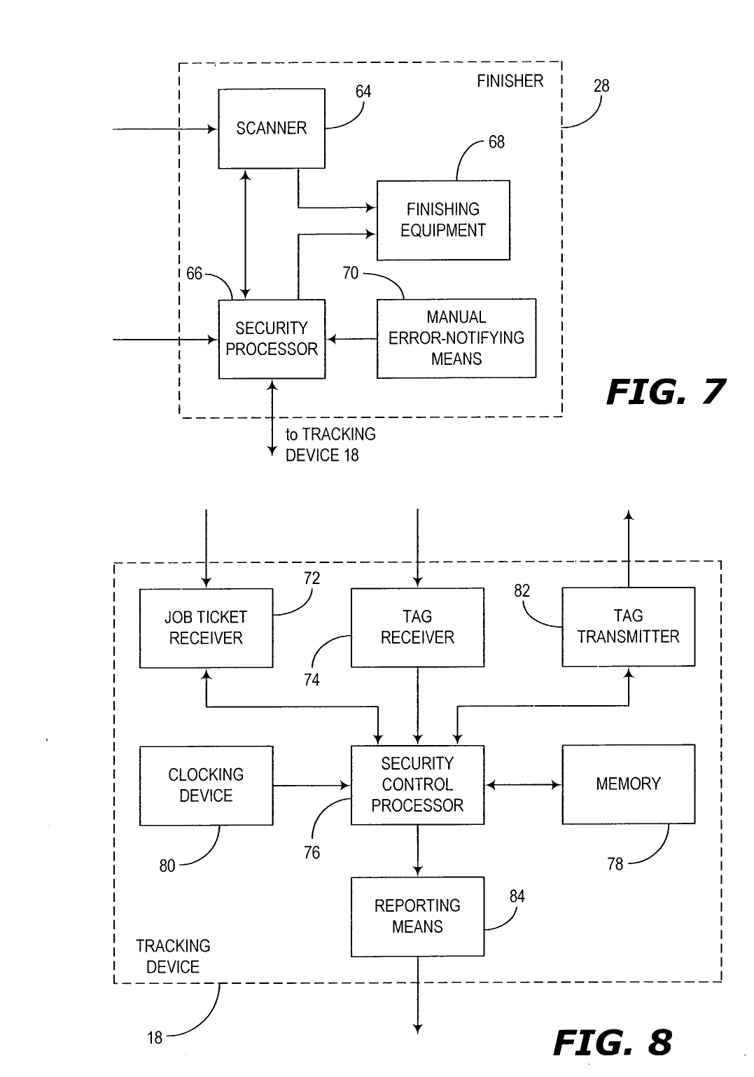

FIG. 6 is a block diagram of an embodiment of the printer 26, as shown in FIG. 2. The data package, having the image data processed by the RIP 24, is received into a security processor 60. The security processor 60 notifies the tracking device 18 of the arrival of the image data, tag, and job ticket, and sends the tag and job ticket to the tracking device 18. Again, the tracking device 18 analyzes the tag and job ticket to verify the security of the data package. If no error or security breach has occurred, the tracking device 18 instructs the security processor 60 to continue. At this point, the security processor 60 decrypts the job ticket to determine the job specified therein and decrypts the tag to determine the location of the sensitive fields.

The security processor 60 sends the image data processed by the RIP 24 to printing equipment 62. The printing equipment 62 utilizes the image data and prints the sensitive and non-sensitive fields together on a recordable medium. The printing equipment 62 may additionally print a header page at the beginning of the print job and a trailer page at the end of the print job. The header and trailer pages encompass the print job to help to separate the printed material from other print jobs. Furthermore, the printing equipment 62 may print coded marks on the header page, trailer page, and/or in the margins of the printed materials. The coded marks may include encoded information, such as in the form of a bar code etc, concerning the identity of the printed documents or instructions for performing post-printing processes. The printing equipment 62 further informs the security processor 60 if any errors or problems were encountered during printing. In response, the security processor 60 notifies the tracking device 18 of the printing success or failure. The security processor 60 also informs the tracking device 18 of the number of pages printed, the number of pages that have an error, and/or the types of problems causing the errors.

The tracking device 18 updates the tag and sends the updated tag to the security processor 60. The security processor 60 outputs the tag and job ticket to the next juncture. However, this security processor 60 does not output the original secured document, since the document has been printed and is contained on the printed material provided by the printing equipment 62. The printed material, along with the header and trailer pages, are output from the printing equipment 62.

FIG. 7 illustrates an embodiment of the finisher 28 as shown in FIG. 2 in which a scanner 64 receives the printed material and a security processor 66 receives the tag and job ticket from the printer 26. The scanner 64 scans the coded marks located on the header page, trailer page, and/or in the margins of the printed material. The scanner 64 informs the security processor 66 of the coded marks. The security processor 66 receives an indication of the number and type of printed pages from the scanner 64 and determines whether all the pages of the printed material have been accounted for. The scanner 64 sends the printed material to finishing equipment 68. According to instructions from the security processor 66 in response to instructions in the decrypted job ticket, the finishing equipment 68 provides finishing procedures such as trimming, cutting, folding, perforating, edging, envelope-stuffing, etc. to the printed material. The scanner 64 and finishing equipment 68 may contain automatic sensors for sensing if an error occurs during scanning or finishing. The finisher 28 may optionally contain a manual error-notifying means 70 for informing the security processor 66 of any errors not recognized by the automatic sensors within the scanner 64 and finishing equipment 68. The manual error-notifying means 70 includes means for allowing an inspector to input information concerning the quality and success of the finishing procedures.

The security processor 66 notifies the tracking device 18 of the success or failure of the finishing equipment 68 based on the conditions sensed by the automatic sensors within the finishing equipment 68 or errors observed by the inspector and input via the manual error-notifying means 70. Since the finisher 28 is the last juncture in the printing job, the tracking device 18 receives the notification from the last security processor 66 and prepares a report. The report includes all of the times and locations of the data package during the transmission of the data package along the network and the success or failure of each job within the junctures.

FIG. 8 is a block diagram of an exemplary embodiment of the tracking device 18, as shown in FIG. 2. A job ticket receiver 72 receives the job ticket from the originator 20 or document augmentation facility 22 (FIG. 2), depending on which element creates or updates the job ticket. The tracking device 18 of FIG. 8 further includes a tag receiver 74 that receives the tag from each of the junctures when the junctures first receive the data package. The received job ticket and tags are input into a security control processor 76 that controls the operations of the tracking device 18. Based on the received job ticket, the security control processor 76 stores the job ticket in memory 78 and utilizes the job ticket to insure that the correct junctures are included in the workflow during transmission of the data package. The tracking device 18 further includes a clocking device 80 that provides an accurate timing signal to the security control processor 76. The timing signal is used by the security control processor 76 to record the time that a tag is received by the tag receiver 74. The times that the tags are received may be stored in the memory 78 so that a record may be maintained that includes information about the location of the data package at all times.

The security control processor 76 includes means for comparing the information within the job ticket with information received from each of the junctures. If the comparing means determines that a discrepancy has occurred, then the security control processor 76 aborts the print job. When the security control processor 76 determines that the print job is progressing according to the specifications of the job ticket, the security control processor 76 updates the new transmission history information based on the information from the latest juncture, updates the tag, and transmits the updated tag using a tag transmitter 82. The updated tag is transmitted to the juncture that is currently processing the data package.

The tracking device 18 includes a reporting means 84. If at any time during the print job an error has occurred, the security control processor 76 detects the error or is informed of such an error. Then the security control processor 76 instructs the reporting means 84 to provide a report to the customer describing the details of the error, such as the location where the error occurred, the time of the error, etc. If no error has occurred during the entire printing process, the reporting means 84 reports that the job has been completed successfully.

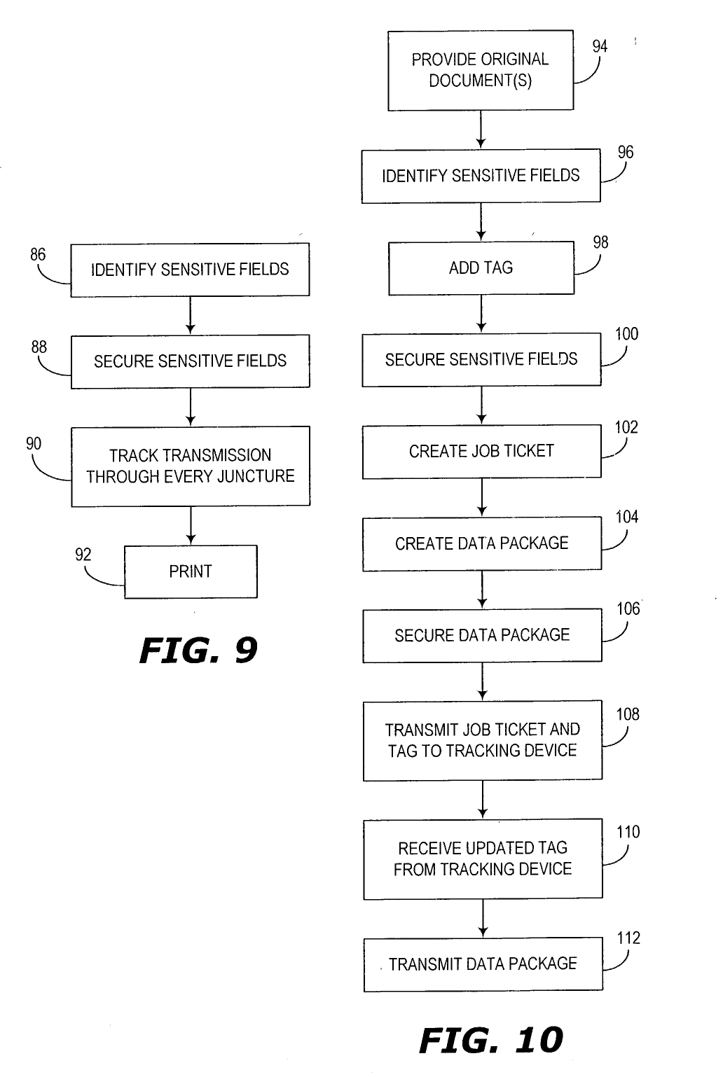

FIGS. 9-13 are flow charts illustrating examples of methods that may be performed by the securing and tracking system 10. Any process descriptions or blocks in flow charts may represent modules, segments, or portions of code which include one or more executable instructions for implementing specific logical functions or steps in the process, and alternate implementations. The identified functions may be executed out of order from that shown or discussed, including substantially concurrently or in reverse order, depending on the functionality involved.

The securing and tracking program, which comprises an ordered listing of executable instructions for implementing logical functions, can be embodied in any computer-readable medium for use by an instruction execution system, apparatus, or device, such as a computer-based system, processor-controlled system, or other system that can fetch the instructions from the instruction execution system, apparatus, or device and execute the instructions. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium. More specific examples of the computerreadable medium include the following: an electrical connection having one or more wires, a portable magnetic computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, for instance, by optical scanning of the paper or other medium, then compiled, interpreted or otherwise processed in a suitable manner if necessary, and then stored in a computer memory. In addition, the scope of the present invention includes embodying the functionality of the embodiments of the present disclosure in logic embodied in hardware or software-configured mediums.

FIG. 9 is an example of a general securing and tracking method. In block 86, the sensitive fields of an electronic document are identified. The identifying procedure is, typically, assisted by the customer who selects the portions of the document that require extra security. In block 88, the identified sensitive fields are secured by available security means. The securing of the sensitive fields may be accomplished using encryption software or circuitry to allow secure transmission of a data package. In block 90, the transmission of the data package is tracked. The tracking is performed by recording the time that the data package arrives at each juncture and the time that the data package departs each juncture. Tracking may further include determining that the junctures are not improperly handling the data package. For instance, improper handling may include improperly storing the data package on unauthorized memory devices, accessing impermissible sensitive fields of the document, etc. In block 92, when the data package has been securely transmitted, the data package is printed at a secure printer.

FIG. 10 illustrates an embodiment of a method for preparing a document to be printed in a secure print job. In block 94, the original document or documents are provided. The provided documents may be previously stored or created or manipulated using data processing tools. In block 96, the sensitive fields of the provided documents are identified. The sensitive fields may include names, addresses, social security numbers, cash values of negotiable instruments, bond issue dates, bank names, checking account numbers, check numbers, savings account numbers, etc. In block 98, a tag is added after the sensitive fields are identified. The tag includes information concerning the location of the identified sensitive fields within the document. In block 100, the sensitive fields are secured using known security and encryption devices.

In block 102, a job ticket is created. The job ticket includes information input from the customer giving instructions as to the junctures that are contracted to perform certain functions with the document. The job ticket includes jobs to be performed, the junctures that are to perform the jobs, and the portions or fields of the document that each contracted juncture is authorized to access. In block 104, a data package is created from the secured document, tag, and job ticket. In block 106, the data package is secured using standard security measures. In block 108, the job ticket and tag are transmitted to a tracking device that processes these elements. When the tracking device finishes processing the job ticket and tag, an updated tag is received from the tracking device, as indicated in block 110. In block 112, the data package is transmitted along a workflow path.

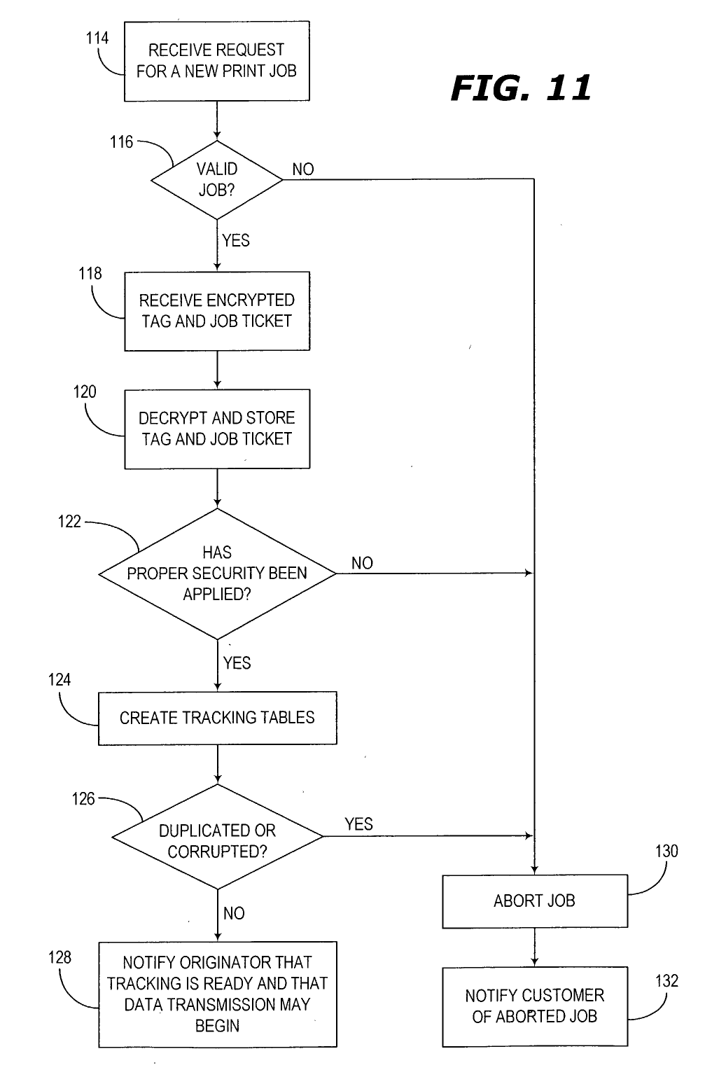

FIG. 11 is a flow chart of a method that may be performed by a tracking device for creating and processing a new print job. In block 114, notification is received from an originator or document augmentation facility concerning a request to initiate a new print job. In decision block 116, the tracking device determines whether the print job request has been received by a qualifying juncture and whether the request is in the proper format. If not, then flow proceeds to block 130. If the job request is valid, flow proceeds to block 118 in which the encrypted job ticket and tag are received. In block 120, the encrypted job ticket and tag are decrypted using an encryption key, and the decrypted information is internally stored. In decision block 122, it is determined whether or not proper security has been applied to the sensitive fields of the document and to the tag and job ticket. If not, then flow proceeds to block 130. Otherwise, flow continues to block 124 wherein tracking tables are created. The tracking tables include an organized database that stores information as it is gathered regarding locations and times of the data package as it is transmitted along the workflow path. The tracking tables may also include storage blocks for inserting information verifying that each particular job item on a checklist of the job ticket has been performed properly.

In decision block 126, it is determined whether or not the job ticket has been inadvertently duplicated such that a request for a print job is repeated unnecessarily. It is also determined whether or not the job ticket is corrupted based on improper junctures being included within the workflow path. If such a problem is detected, flow proceeds to block 130. Otherwise, flow proceeds to block 128 in which the tracking device notifies the originator or document augmentation facility that tracking is ready and that the transmission of the data package may begin.

When an error has been detected in one of blocks 116, 122, or 126, the entire print job is aborted, as indicated in block 130. When the print job is aborted, the data package is completely erased from memory locations within each juncture as well as the memory of the tracking device. In block 132, the tracking device notifies the customer that the print job has been stopped and abandoned. The tracking device may also provide a report detailing the conditions that arose to cause the tracking device to stop the job.

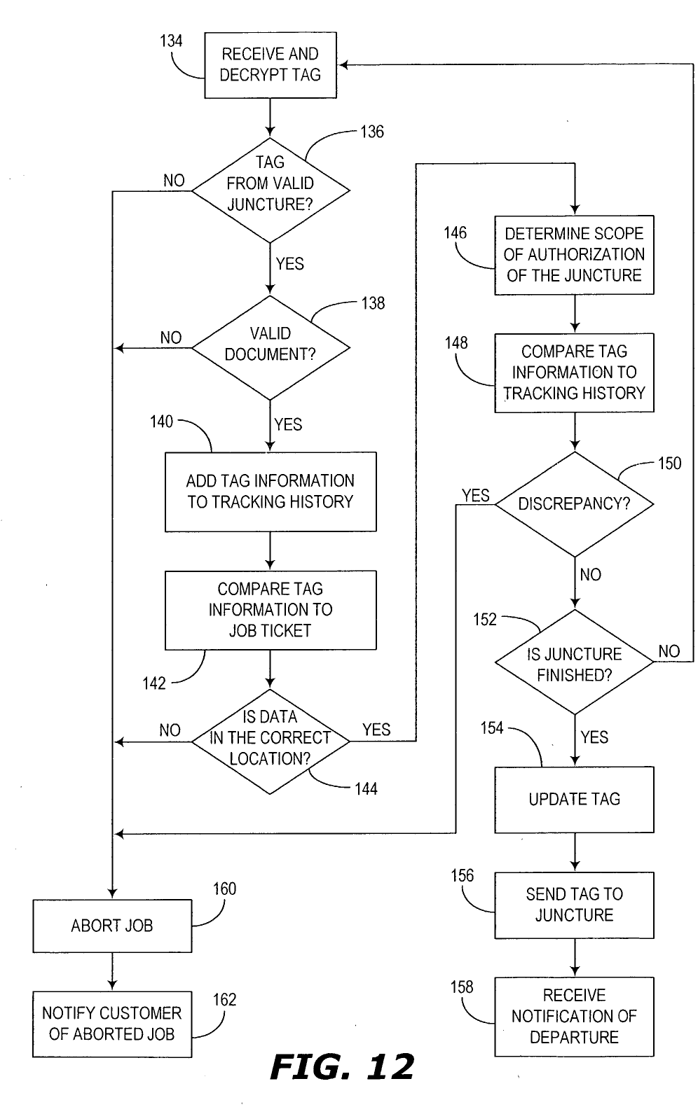

FIG. 12 is a block diagram of an embodiment of a tracking method for tracking the transmission of a data package along a workflow path on a network. This tracking method is typically performed after a print job has been established and a tag and job ticket have already been created. In block 134, a tracking device receives a tag from a juncture and decrypts the tag. In decision block 136, the tracking device determines whether the tag is from a valid juncture. If not, flow proceeds to block 160. If the tag is from a valid juncture, flow proceeds to decision block 138. In block 138, the tracking device determines whether or not the document is valid. If not, flow proceeds to block 160, but if so, flow proceeds to block 140. In block 140, the information contained within the tag is added to a tracking history. The tracking history may be stored in tracking tables or other suitable record-keeping memory device. In block 142, the information in the tag is compared with the job ticket information. In block 144, if the comparison from block 142 indicates that the data package has not been received by the correct juncture location, then decision block 144 directs flow to block 160. If the data package is at the correct juncture, then flow proceeds to block 146. The detection of the correct location may include detecting the proper sequence of junctures as well. If, for some reason, a juncture is skipped, then the data package is not in the correct location, even though the next juncture may be a legitimate juncture.

In block 146, the scope of authority given to the particular juncture is determined by observing the information contained within the job ticket. In block 148, the transmission information within the received and decrypted tag is compared with the transmission history or tracking tables. In block decision 150, it is determined whether or not any discrepancy existed with the comparison. Such a discrepancy may arise as a result of improperly tampering with the tag in one of the junctures. If a discrepancy exists, flow proceeds to block 160, and, if not, then flow proceeds to block 152. In decision block 152, it is determined whether or not all the jobs have been completed by the juncture. If not, then flow proceeds to block 134 where the steps are repeated for additional jobs to be performed by the juncture. If the juncture has completed all jobs, then flow continues to block 154 in which the tag is updated. In block 156, the updated tag is sent back to the juncture. In block 158, the tracking device receives notification of the departure of the data package.

When an invalidity situation occurs in blocks 136 or 138, or a discrepancy has arisen in blocks 144 or 150, the flow proceeds to block 160. In block 160, the tracking device determines that an error has occurred and aborts the print job. In block 162, the tracking device notifies the customer of the stoppage of the print job and reports what type of error has occurred.

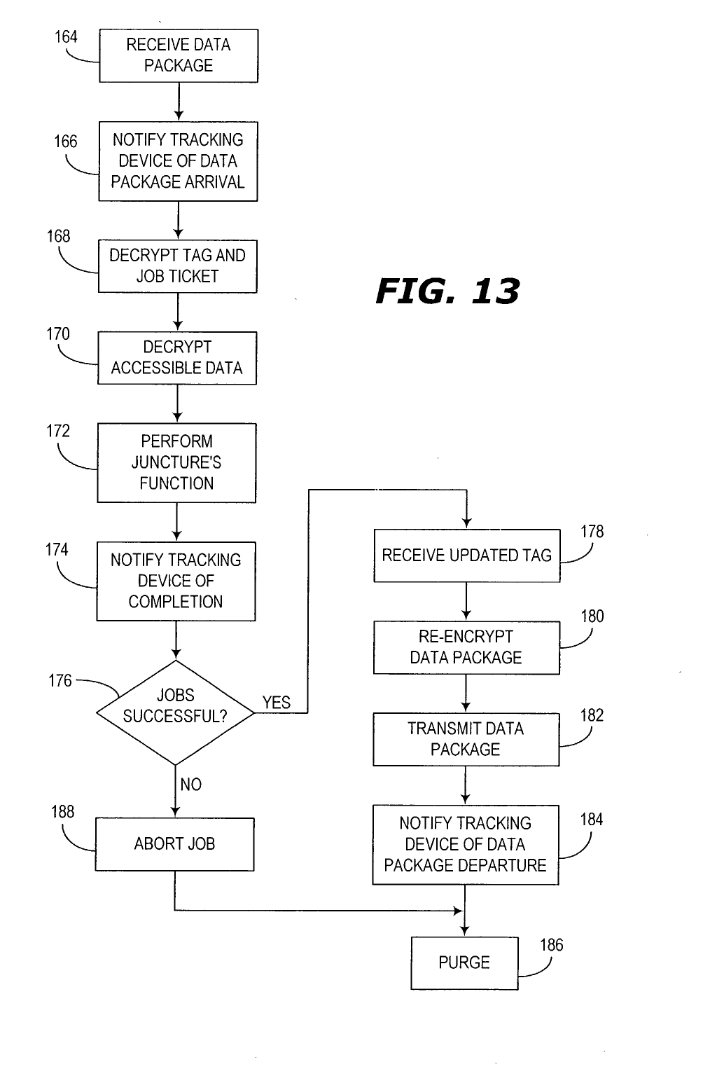

FIG. 13 illustrates an example of a method for tracking the transmission of the data package, from the perspective of the individual junctures. Particularly, the method of FIG. 13 applies to the function performed by the junctures after the tag and job ticket have been created. In block 164, the juncture receives the data package from the network. In block 166, the juncture notifies the tracking device that the data package has arrived. In block 168, the juncture is notified by the tracking device to continue and decrypts the tag and job ticket. In block 170, the accessible sensitive or non-sensitive data that the juncture is authorized to process is decrypted. The determination of which portions or fields of the data are accessible to the particular juncture is made by observing the information in the job ticket. In block 172, the juncture performs its designated function by processing the sensitive and/or non-sensitive fields of the document according to the instructions within the job ticket.

In block 174, when the juncture has completed its job or jobs, the juncture notifies the tracking device that the jobs have been completed. In decision block 176, a determination is made whether the jobs have been performed successfully. If not, flow proceeds to block 188. If the juncture has successfully performed its designated functions, flow proceeds to block 178 in which the juncture wait to receive the updated tag from the tracking device. The updated tag is incorporated back into the data package and the data package is re-encrypted, as indicated in block 180. In block 182, the data package is transmitted back onto the network to the next juncture. In block 184, after transmitting the data package, the juncture notifies the tracking device of the departure of the data package. In block 186, the juncture purges all of its electronic and physical storage devices of any remnants of the data package. The purging includes erasing memory components, removing images from processors or physical elements, etc. If one of the jobs performed by the juncture is determined to be unsuccessful in block 176, the entire print job is aborted, as indicated in block 188. Then, as indicated in block 186, the memory elements and physical elements storing images of the document are purged.

It should be emphasized that the above-described embodiments of the present invention are merely examples of possible implementations, set forth for a clear understanding of the principles of the invention. Many variations and modifications may be made to the above-described embodiments of the invention without departing from the principles of the invention. All such modifications and variations are intended to be included herein within the scope of this disclosure and protected by the following claims.

We claim:

1. A securing and tracking system comprising:
a data package comprising a document, a tag, and a job ticket, the document having sensitive and non-sensitive fields, the tag having information about the locations of the sensitive fields within the document, and the job ticket having information about jobs to be performed on the document;
a plurality of junctures connected to a network, each juncture having a security processor, wherein a first juncture is a customer that provides the data package and a last juncture is a printing facility that performs a printing job, the junctures configured to transmit the data package along a workflow path on the network from an originator to the printing facility; and
a tracking device in communication with the security processors, the tracking device configured to monitor the location of the data package along the workflow path at all times.

2. The securing and tracking system of claim 1, wherein the tracking device further ensures that the locations of the sensitive fields within the document are secured.

3. The securing and tracking system of claim 1, wherein the originator further comprises a print-job initiator comprising a sensitive field identifier, a tag adder, and a job ticket creator.

4. The securing and tracking system of claim 3, wherein the originator inputs information into the sensitive field identifier to identify the sensitive fields within the document, and the tag adder adds the tag having information based on the location of the sensitive fields identified by the sensitive field identifier.

5. The securing and tracking system of claim 3, wherein the originator inputs information into the job ticket creator to request jobs to be performed by the junctures.

6. The securing and tracking system of claim 1, wherein one of the junctures is a raster image processor (RIP), another juncture is a printer, and another juncture is a finisher.

7. The securing and tracking system of claim 6, wherein the printing facility comprises the RIP, printer, and finisher.

8. The securing and tracking system of claim 6, wherein the RIP processes the data package to convert the document into images that the printer recognizes.

9. The securing and tracking system of claim 1, wherein an interposed juncture is a document augmentation facility that enhances the document.

10. The securing and tracking system of claim 9, wherein the document augmentation facility comprises a sensitive field identifier, a tag adder, and a job ticket creator, the document augmentation facility being configured to identify sensitive fields and to create a job ticket.

11. The securing and tracking system of claim 1, wherein the tag further comprises information about the location of the document at all times, the tracking device updating the tag when the data package arrives and departs each juncture.

12. The securing and tracking system of claim 1, wherein the communication between the tracking device and the security processors includes the transmitting and receiving of the tag and job ticket.

13. The securing and tracking system of claim 1, wherein the job ticket is further configured to store information concerning which junctures are authorized to access portions of the document.

14. The securing and tracking system of claim 1, wherein the network is an open network.

15. The securing and tracking system of claim 14, wherein the open network is the Internet.

16. The securing and tracking system of claim 1, wherein the security processors comprise an encryption key that allow the junctures to decrypt the tag and job ticket and to access portions of the document based on information in the job ticket.

17. A method of securing and tracking a document transmitted through secure junctures over an open network, the method comprising the steps of:
securing sensitive fields within the document;
transmitting the document along a workflow path through the secure junctures;
tracking the location of the document through the secure junctures; and
printing the document.

18. The method of claim 17, wherein the step of securing comprises:
identifying the sensitive fields; and
adding a tag to the document, the tag indicating the location of the identified sensitive fields.

19. The method of claim 18, wherein the step of transmitting further comprises creating a job ticket containing a description of jobs to be performed on the document and creating a data package from the document, tag, and job ticket.

20. The method of claim 19, wherein the step of transmitting further comprises transmitting the tag and job ticket to a tracking device and waiting for a response from the tracking device.

21. A method for securing a document to be transmitted to a remote printing facility, the method comprising the steps of:
receiving from an originator a request for a new print job to be performed;
determining the validity of the print job request;
notifying the originator that transmission of the document may begin when the print job request is determined to be valid; and
aborting the print job when the print job request is determined to be invalid.

22. The method of claim 21, wherein the step of determining comprises determining whether proper security has been applied to the document.

23. The method of claim 21, further the step of determining comprises determining whether the request for a new print job has been duplicated or corrupted.

24. A method of tracking a document transmitted through a plurality of junctures along a workflow path to a printing facility, the junctures carrying out requested jobs according to a job ticket, the method comprising the steps of:
receiving a tag from a juncture;
decrypting the tag;
comparing information contained with the tag to information contained within the job ticket;
determining the validity of the information contained within the tag; and
updating a transmission history.

25. The method of claim 24, wherein the step of determining comprises determining whether the tag has been received from a valid juncture.

26. The method of claim 24, wherein the step of determining comprises determining whether the tag is related to a valid document.

27. The method of claim 24, further comprising the steps of:
aborting the jobs when the step of determining reveals an occurrence of invalidity; and
notifying a customer that the jobs have been aborted.

28. The method of claim 24, further comprising the steps of:
determining the scope of authorization of the juncture;
comparing the information within the tag to the tracking history; and
determining whether a discrepancy has occurred between the information within the tag and the tracking history.

29. The method of claim 24, further comprising the steps of:
storing the updating transmission history within the tag;
transmitting the updated tag to the juncture; and
receiving notification from the juncture of the departure time of the document from the juncture.

30. A method for processing a print job for a document transmitted along a workflow path from an originator to a printing facility, the method comprising the steps of:
receiving a data package comprising a document to be printed, a tag, and a job ticket;
notifying a tracking device when the data package is received;
decrypting portions of the data package;
performing a function on the data package as described in the job ticket; and
notifying the tracking device when the function is complete.

31. The method of claim 30, wherein the step of decrypting comprises decrypting the tag, job ticket, and permitted portions of the document.

32. The method of claim 30, further comprising the step of determining whether the intended function has been performed successfully.

33. The method of claim 32, further comprising the steps of:
receiving an updated tag from the tracking device;
re-encrypting the data package;
transmitting the data package along the workflow path;
notifying the tracking device that the data package has departed; and
purging memory devices of all remnants of the data package.

34. A tracking device for controlling and tracking a document transmitted along a workflow path to a printing facility, the document comprising sensitive and non-sensitive fields, the tracking device comprising:
a job ticket receiver for receiving from a customer a job ticket describing jobs to be performed on the document;
a tag receiver for receiving tags from junctures located along the workflow path;
a tag transmitter for transmitting updated tags to the junctures; and
a security control processor connected to the job ticket receiver, tag receiver, and tag transmitter.

35. The tracking device of claim 34, further comprising:
a clocking device for providing a reliable time signal to the security control processor; and
memory connected to the security control processor, the memory containing tracking tables for storing the transmission history of the document.

36. The tracking device of claim 34, further comprising a reporting means for reporting the status of the document during transmission, the reporting means sending a report of the success of a print job when the security control processor detects no errors and sending a report of the failure of the print job when the security control processor detects an error.

37. The tracking device of claim 36, wherein the security control processor aborts the entire print job when an error has been detected.

38. A system for securing and tracking a document transmitted along a workflow path from a customer to a remote printing facility, the system comprising:
a customer having a document source, a print-job initiator, and a security processor, the document source providing a document, the print-job initiator identifying sensitive fields within the document and establishing a print job;
a printing facility connected to the customer along the workflow path, the printing facility having printing equipment and a security processor; and
a tracking device in communication with the security processors of the customer and printing facility.

39. A computer network for securing and tracking a document, the computer network comprising:
a plurality of secure junctures connected to an open network, at least one secure juncture comprising logic configured to secure sensitive fields within the document;
logic configured to transmit the document along a workflow path through the secure junctures;
a tracking device connected to the secure junctures, the tracking device comprising logic configured to track the location of the document through the secure junctures; and
logic configured to print the document.

40. The computer network of claim 39, wherein the logic configured to secure the sensitive fields further comprises:
logic configured to identify the sensitive fields; and
logic configured to add a tag to the document, the tag indicating the location of the identified sensitive fields.

41. The computer network of claim 40, wherein the logic configured to transmit the document further comprises:
logic configured to create a job ticket containing a description of jobs to be performed on the document; and
logic configured to create a data package from the document, tag, and job ticket.

42. The computer network of claim 41, wherein the logic configured to transmit the document further comprises:
logic configured to transmit the tag and job ticket to the tracking device; and
logic configured to receive a response from the tracking device.

43. The computer network of claim 41, wherein each secure juncture further comprises:
logic configured to receive the data package;
logic configured to notify the tracking device when the data package is received;
logic configured to decrypt portions of the data package;
logic configured to perform a function on the data package as described in the job ticket; and
logic configured to notify the tracking device when the function is complete.

44. The computer network of claim 39, wherein the tracking device further comprises:
logic configured to receive from an originator a request for a new print job to be performed;
logic configured to determine the validity of the print job request;
logic configured to notify the originator, when the print job request is determined to be valid, that transmission of the document may begin; and
logic configured to abort the print job when the print job request is determined to be invalid.

45. The computer network of claim 44, wherein the tracking device further comprises:
logic configured to receive the tag from the secure junctures;
logic configured to decrypt the tag;
logic configured to compare information contained with the tag to information contained within the job ticket;
logic configured to determine the validity of the information contained within the tag; and
logic configured to update a transmission history.

46. A system for securing and tracking a document transmitted through secure junctures over an open network, the system comprising:
means for securing sensitive fields within the document;
means for transmitting the document along a workflow path through the secure junctures;
means for tracking the location of the document through the secure junctures; and
means for printing the document.

47. The system of claim 46, wherein the means for securing further comprises:
means for identifying the sensitive fields; and
means for adding a tag to the document, the tag indicating the location of the identified sensitive fields.

48. A computer program stored on a computer-readable medium, the computer program comprising:
logic configured to identify sensitive fields within the document;
logic configured to add a tag to the document, the tag indicating the location of the sensitive fields;
logic configured to transmit the document along a workflow path through secure junctures connected to an open network;
logic configured to track the location of the document through the secure junctures; and
logic configured to print the document.

49. The computer program of claim 48, wherein the logic configured to transmit the document further comprises:
logic configured to create a job ticket containing a description of jobs to be performed on the document; and
logic configured to create a data package from the document, tag, and job ticket.
